(19) United States
(12) Patent Application Publication
(10) Pub. No.: US 2008/0117136 A1
(43) Pub. Date: May 22, 2008

(54) Plasma display device and image processing method thereof

(76) Inventor: Jongwook Kim, Yongin-si (KR)

Correspondence Address: ROBERT E. BUSHNELL, 1522 K STREET NW, SUITE 300, WASHINGTON, DC, 20005-1202, US

(21) Appl. No.: 11/984,655

(22) Filed: Nov. 20, 2007

(30) Foreign Application Priority Data
Nov. 21, 2006 (KR) 10-2006-0115246

(51) Int. Cl. G09G 3/28

(52) U.S. Cl. 345/60

(57) ABSTRACT

Disclosed are a plasma display device and an image processing method thereof, which can decrease stresses of an address circuit by reducing the number of address switching without decreasing the brightness, contrast ratio and clearness of images. The plasma display device includes a pattern detecting and determining unit for detecting a pattern of an image that is represented by red (R), green (G), and blue (B) image signals. The pattern detecting and determining unit determines whether the detected pattern of the image is identical to a preset specified pattern. The plasma display device includes a blurring unit for blurring at least one of R, G and B image signals if the detected pattern of the image is identical to the present specified pattern.

### CLAIM FOR PRIORITY

This application makes reference to, incorporates the same herein, and claims all benefits accruing under 35 U.S.C. §119 from an application earlier filed in the Korean Intellectual Property Office on Nov. 21, 2006 and there duly assigned Serial No. 10-2006-0115246.

### BACKGROUND OF THE INVENTION

1. Field of the Invention

The present invention relates to a plasma display device and an image processing method that improves reliability of driving of the plasma display device without degrading the image quality.

2. Description of the Related Art

Generally, a plasma display panel is classified into a DC (Direct Current) type plasma display panel and an AC (Alternating current) type plasma display panel according to an applied driving voltage and the structure of a discharging cell. In case of the AC type plasma display panel, a dielectric layer covers an electrode, which results in capacitance formation. The capacitance limits currents, so that the electrode is protected from ion bombardment during discharging. Consequently, the AC type plasma display panel has longer durability than that of the DC type plasma display panel. In case of the DC type plasma display panel, an electrode is exposed to a discharging space, so that discharge currents flow while applying a voltage. Accordingly, a resistor should be inserted into every unit pixel in order to limit currents. This is a remarkable difference in the structures between the DC type plasma display panel and the AC type plasma display panel. One of the significant characteristics of the AC type plasma display panel is that a dielectric layer covers the electrode. Therefore, when the current flows, charges entered into to the electrode are accumulated on the surface of the dielectric layer as a type of wall charge, so that discharge current is self-controlled by the internal electric field opposite to the electric filed applied from the outside.

The AC type plasma display panels are further classified into a facing electrode type it plasma display panel and a surface discharge type plasma display panel. Referring to FIG. 1, an AC surface discharge type plasma display panel is illustrated by a partial sectional perspective diagram.

A plasma display panel 100′ includes a front substrate 110′ and a rear substrate 120′. A scan electrode 112′ and a sustain electrode 113′ are formed in parallel to each other on a lower surface of the front substrate 110′. The scan electrode 112′, included in display electrodes 114′ for display discharge, includes a transparent electrode 112a′ and a low resistance bus electrode 112b′, and the sustain electrode 113′ includes a transparent electrode 113a′ and a low resistance bus electrode 113b′. All of the display electrodes 114′ are covered with a first dielectric layer 115′ for accumulating wall charges. Further, a protective layer 116′ is formed on the surface of the first dielectric layer 115′ for protecting the display electrodes 114′ and the first dielectric layer 115′ from discharge.

A plurality of address electrodes 122′ is formed in parallel with each other on an upper surface of the rear substrate 120′ so as to supply an address signal. Further, a second dielectric layer 123′ is formed in a predetermined thickness on the surface of all of the address electrodes 122′ so as to protect the surface thereof. Further, a barrier rib 124′ is formed on the surface of the second dielectric layer 123′ to be opposed with each other, so that a discharging region having a predetermined size is formed. The address electrodes 122′ are formed between the barrier ribs 124′ and simultaneously in parallel with the barrier ribs 124′. The address electrodes 122′ are formed by intersecting with the display electrodes 114′. Additionally, phosphor layers 125′, which are excited by ultra-violet radiation and then emit visible light of a predetermined color, are formed respectively between the barrier ribs 124′ on the second dielectric layer 123′ on the address electrodes 122′. For instance, the phosphor layers 125′ may be red, green and blue phosphor layers.

It is difficult for the plasma display panel to control light intensity (gray scale expression) in each pixel when displaying on a screen. Referring to FIG. 2, one example of gray scale expression methods is illustrated. Referring to FIG. 2, one frame (one TV field) is divided into a plurality of sub-fields and then controlled by time-division, so that the gray scale of a plasma display panel is expressed. Particularly, each sub-field includes a reset period, an address period and a sustain period. FIG. 2 illustrates that one frame is divided into 8 sub-fields in order to express 256 gray scales. Each of the sub-fields (SF1-SF8) includes the reset period (not shown), the address period (A1-A8) and the sustain period (S1-S8) and the sustain periods (S1-S8) have a luminous period ratio (1T, 2T, 4T, 8T, 16T, 32T, 64T, 128T) of 1:2:4:8:16:32:64:128. For instance, in order to express 3 gray scales, a discharging cell is discharged in the sub-field SF1 having the luminous period 1T and the sub-field SF2 having the luminous period 2T, and thus the sum of the discharge periods becomes to 3T. This enables an image of 256 gray scales to be expressed by a combination of sub-fields having different luminous periods from each other. Each sub-field is divided according to a sustain period ratio and then combined with each other so as to express a gray scale, however, actually, the sustain period of each sub-field has a different sustain pulse number, so that gray scales are expressed by a combination of the sustain pulse numbers.

Further, the plasma display panel generally adopts an automatic power control (APC) method in order to minimize power consumption. The APC controls the total number of sustain pulses of one frame according to the average signal level (ASL) of an inputted image signal. When an ASL value of an input image signal is high, large power consumption is required, because the entire screen is bright. Accordingly, in order to suppress power consumption, the total number of sustain pulses of one frame is reduced. When an ASL value of an input image signal is low, large power consumption is not required, because the entire screen is dark. Accordingly, the total number of sustain pulses of one frame is increased. Here, there are several levels of APC according to the ASL of the inputted image signal, and the number of sustain pulses corresponding to the several levels of APC is pre-set. In other words, when an APC level is high, i.e., when an ASL value is high, the total number of sustain pulses of one frame is relatively reduced and thus, the number of sustain pulses allocated to each sub-field is relatively reduced.

Meanwhile, the plasma display device having such structure, gray scale expression method and APC function often outputs an image with a line on-off pattern and a pattern having the same characteristic as a line on-off pattern. For instance, the line on-off pattern is repeated in such a way that a first horizontal line of the plasma display panel is turned-on, a second horizontal line is turned-off, and a third horizontal line is turned-on.

An address signal should be applied to most of address electrodes in an image pattern having the same characteristic as the line on-off pattern, so that the number of address switching is necessarily increased. Accordingly, a great amount of displacement currents flow through the surface of the dielectric layer according to increases in the number of address switching. This increases power consumption as well as current and temperature stresses on an address-associated circuit, and induces a noise and an electromagnetic wave. Occasionally, the address-associated circuit is damaged.

Conventionally, an address APC algorithm similar to the above described APC was introduced in order to prevent such problem. In other words, the conventional APC lowers a gray scale by controlling a gain of an input image signal and thus controls address power by reducing the discharge number of the sub-fields of a most significant bit (MSB). However, if the gain of the input image signal is lowered, brightness and contrast ratio are necessarily reduced. Further, a moving image and a still image are distinguished to each other in order to prevent brightness flicker from being generated from the moving image. If the moving image were not distinguished from the still image clearly, the flicker would occur therein. In other words, since the address ACP basically prevents heat generation in a Tape Carrier Package (TCP), noises and damages caused by the continuance of a specific pattern, this specific pattern is rarely continued in the moving image. Further, since there should not be a brightness difference between the moving image and a previous image, the address APC is not operated in the moving image. Accordingly, when an image has the obscure motion of a specific pattern, the image is likely to be present on the borderline between the moving image and the still image. In this time, an address APC algorithm generates the brightness flicker while being on and off repeatedly.

Meanwhile, in order to solve the problem, a method for blurring the entire image can be considered. In other words, by reducing entirely a difference in the gray scale between lines that are displayed on a screen of the plasma display panel using an average filter, the number of address switching operations can be reduced by blurring the entire screen. However, if the number of address switching operations is reduced, the brightness, the clarity and the contrast ratio of the screen are remarkably reduced.

### SUMMARY OF THE INVENTION

Accordingly, the present invention is to provide a plasma display device and an image processing method thereof, which decrease stresses of an address circuit by reducing the number of address switching operations without decreasing the brightness, contrast ratio and clarity of images.

According to an aspect of the present invention, there is provided a plasma display device, which includes a pattern detecting and determining unit detecting a pattern of an image that is represented by a red (R), a blue (B), and a green (G) image signals, and a blurring unit coupled to the pattern detecting and determining unit. The pattern detecting and determining unit determines whether the detected pattern of the image is identical to a preset specified pattern, and the blurring unit blurs at least one of R, G, and B image signals if the detected pattern of the image is identical to the preset specified pattern.

The preset specified pattern may include a line on-off pattern. The blurring unit may blur the R image signal. The blurring unit may blur the B image signal. The blurring unit may delay the output of the G image signal by a time period that is required to blur at least one of R and B image signals. The blurring unit may blur at least one of the R and B image signals and may delay the G image signal by the blurring process time of the at least one of the R and B image signals.

The plasma display device may further include a sub-field converter electrically coupled to the blurring unit. The sub-field converter converts R, B, and G image signals output from the blurring unit to a sub-field corresponding to a predetermined gray scale, if the detected pattern of the image is identical to the preset specified pattern.

The plasma display device may further include a bypass unit electrically coupled to the pattern detecting and determining unit. The R, G, and B image signals may pass through the bypass unit and may not pass through the blurring unit if the detected pattern of the image is not identical to the preset specified pattern. The plasma display device may further include a sub-field converter electrically coupled to each of the blurring unit and the bypass unit. The sub-field converter converts R, B, and G image signals output from the blurring unit or from the bypass unit to a sub-field corresponding to a predetermined gray scale.

According to another aspect of the present invention, there is provided an image processing method of the plasma display device, which includes steps of detecting a pattern of an image that is represented by a red (R), a green (G), and a blue (B) image signals, determining whether the detected pattern of the image is identical to a preset specified pattern, and blurring at least one of the R, G and B image signals if the detected pattern of the image is identical to the preset specified pattern.

The preset specified pattern may include a line on-off pattern. The step of blurring at least one of the R, G, and B image signals may include a step of blurring the R image signal. The step of blurring at least one of the R, G, and B image signals may include a step of blurring the B image signal. The step of blurring at least one of the R, G, and B image signals may include a step of delaying the output of the G image signal by a time period that is required to blur at least one of R and B image signals.

The step of blurring at least one of the R, G and B image signals may further include steps of blurring at least one of R and B image signals, and delaying the output of the G image signal by a time period that is required to blur the at least one of R and B image signals.

The image processing method may further include a step of converting the blurred at least one of the R, B, and G image signals to a sub-field corresponding to a predetermined gray scale if the detected pattern of the image is identical to the preset specified pattern.

The image processing method may further include a step of not blurring all of the R, G and B image signals, if the detected pattern of the image is not identical to the preset specified pattern. The image processing method may further include a step of converting the not blurred R, B, and G image signals to a sub-field corresponding to a predetermined gray scale, if the detected pattern of the image is not identical to the preset specified pattern.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial sectional perspective diagram illustrating a structure of an AC surface discharge type plasma display panel;

FIG. 2 is a diagram illustrating an example of gray scale expression methods;

FIG. 3 is a block diagram illustrating components of a plasma display device constructed as an embodiment of the present invention;

FIG. 4 is a detailed block diagram illustrating components of a controller of the plasma display device of FIG. 3;

FIG. 5a is a diagram showing an example of an average filter;

FIG. 5b is a diagram showing an example of a uniform filter;

FIG. 6 is a flow chart illustrating an image processing method of the plasma display device of the present invention;

FIG. 7a is a photo of an original sample image that is input into a plasma display device;

FIG. 7b is a photo of a blurred sample image in which only R and B image signals are blurred;

FIG. 7c is a photo of a blurred sample image when all of R, G and B image signals are blurred; and

FIG. 8 shows an example of a line on-off pattern.

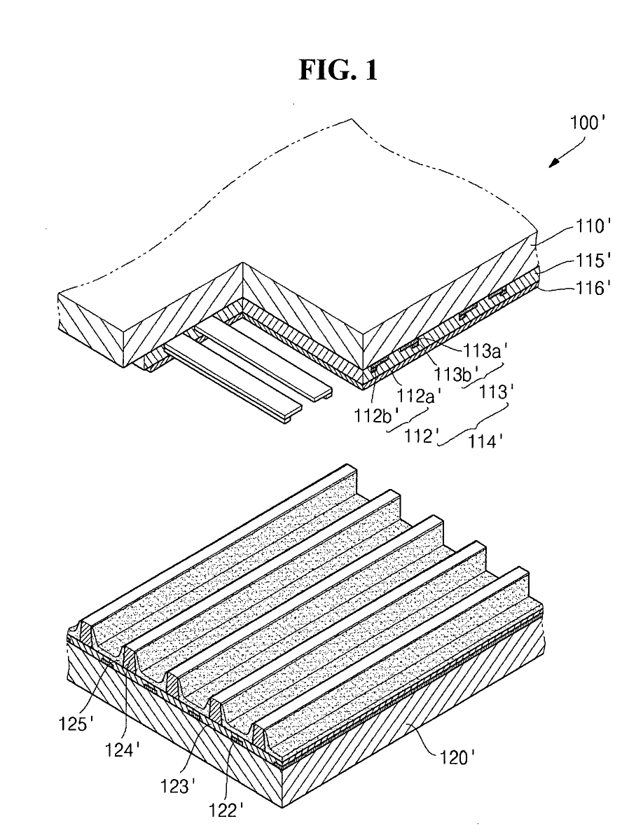

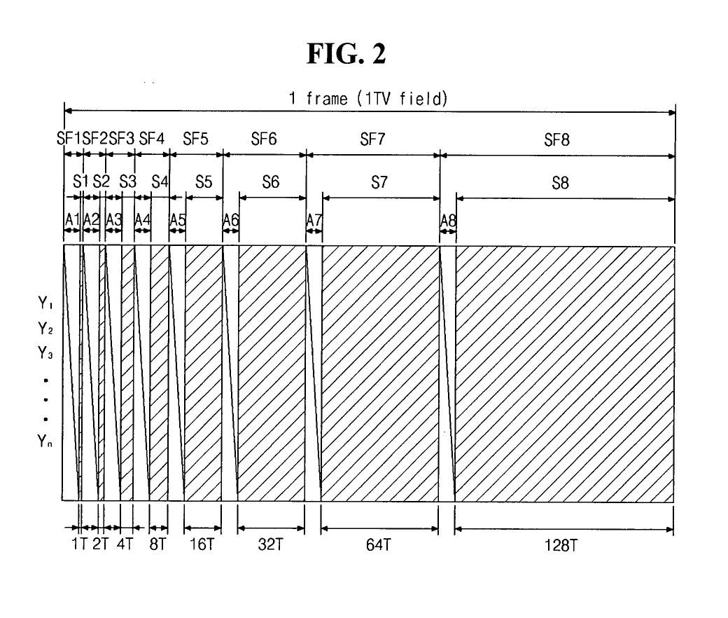

### DETAILED DESCRIPTION OF THE INVENTION

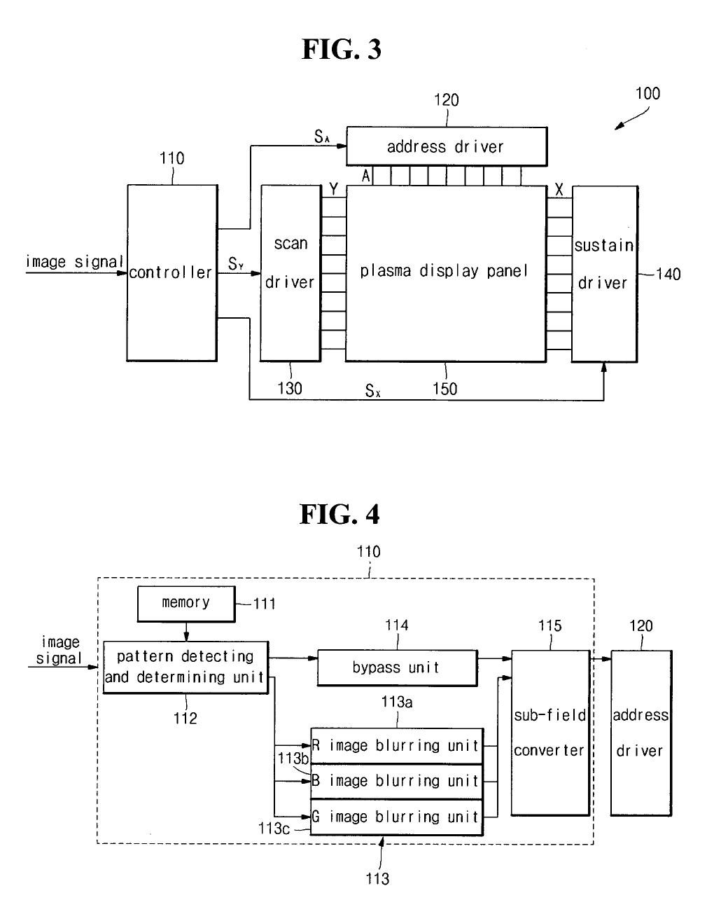

FIG. 3 is a block diagram illustrating components of a plasma display device 100 constructed as an embodiment of the present invention. Referring to FIG. 3, the plasma display device 100 includes a controller 110, an address driver 120, a scan driver 130, a sustain driver 140 and a plasma display panel 150. The scan driver 130 and the sustain driver 140 can be manufactured to be integrated together. However, in the descriptions of the present invention, the scan driver 130 and the sustain driver 140 are described as separated components for the purpose of clarification.

If a specified pattern exists in an image that is represented by red (R), green (G) and blue (B) image signals to be input, the controller 110 outputs an address driving signal S_{A} obtained by blurring at least one of the R, G and B image signals. The controller 110 also outputs a scan driving signal S_{Y} and a sustain driving signal S_{X}.

The address driver 120 receives the address driving signal S_{A} from the controller 110 so as to provide an address signal A to an address electrode of the plasma display panel 150. Discharging cells to be turned on or off in the plasma display panel 150 are selected by the address signal A.

The scan driver 130 receives the scan driving signal S_{Y} from the controller 110 so as to provide a scan signal Y to a scan electrode of the plasma display panel 150. Discharging cells to be turned on are driven by the scan signal Y. The scan driver 130 outputs the scan signal Y, a rest signal for resetting all discharging cells in the plasma display panel 150, and another sustain signal that alternates with a sustain signal outputted from the sustain driver 140. This driving method is, however, known to those skilled in the art and thus will be not described here in detail.

The sustain driver 140 receives the sustain driving signal S_{X} from the controller 110 so as to provide a sustain signal X to a sustain electrode of the plasma display panel 150. As described above, when the sustain driver 140 outputs the sustain signal X, the scan driver 130 also outputs another sustain signal that alternates with the sustain signal X.

The plasma display panel 150, which receives the address signal A, the scan signal Y and the sustain signal X from the address driver 120, the scan driver 130 and the sustain driver 140, respectively, displays an image. An image can be represented by one frame (or one TV field) that includes sub-fields, each of which includes a reset period, an address period and a sustain period that can be made by various combinations of signals outputted from the drivers. A plurality of frames forms a still image or moving images.

Referring to FIG. 4, the components of the controller 110 of the plasma display device 100 of FIG. 3 will be described in detail. The controller 110 includes a memory 111, a pattern detecting and determining unit 112, a blurring unit 113 and a bypass unit 114. Additionally, a sub-field converter 115 may be further electrically coupled to the blurring unit 113 and the bypass unit 114, and the address driver 120 is further electrically coupled to the sub-field converter 115.

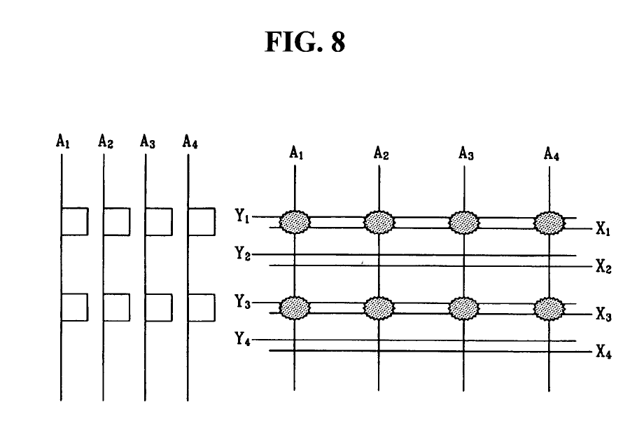

The memory 111 stores a specified pattern. An example of the specified pattern is a line on-off pattern, which is shown in FIG. 8. In the line on-off pattern, a completely turned on line alternates with a completely turned off line. One of the reasons that the line on-off pattern is selected as an example is that the line on-off pattern induces an excessive number of address switching operation. The specified pattern of the present invention, however, is not limited to the line on-off pattern. Any pattern that could induce an excessive number of address switching operation can be selected as a specified pattern. Any pattern having a specific purpose can be selected as a specified pattern. The memory 111 also can store various specified patterns.

The pattern detecting and determining unit 112 detects a pattern from R, G and B image signals and determines whether the detected pattern is the same type as a pre-stored specified pattern or not. The R, G and B image signals to be input to the pattern detecting and determining unit 112 are in a status of pre-converting an analog signal to a digital signal and further in a status of being gamma corrected to be suitable for the characteristic of the plasma display panel 150. However, the present invention is not limited thereto.

The blurring unit 113 blurs at least one of the R, G and B image signals and outputs the blurred image signal, if the detected pattern is the same as the specified pattern.

Particularly, the blurring unit 113 can includes R image blurring unit 113a, B image blurring unit 113b, and G image blurring unit 113c. If it is necessary to blur all of the R, B, and G images, R, B, and G blurring units 113a, 113b, and 113c blur R, B, and G image signals, respectively. However, if it is necessary to blur only two of the R, B, and G images, for example, only R and B images, R and B image blurring unit 113a and 113b blur the R and B image signals, but G image blurring unit 113c can be a delaying unit that delays the output of G image signal by the time period that is required to blur the R and B image signals. In the present specification, the units 113a, 113b, and 113c are referred to as image blurring units, but these units also can be delay units depending on the applications. With the same principle, if only one of the R, B, and G images is required to be blurred, for example, the R image, then the B and G blurring units 113b and 113c can be delays units. In this case, R image blurring unit 113a blurs the R image signal, while the B and G blurring units 113b and 113c delay the output time of the B and G image signals, respectively. The decision about which image blurring unit can be a delay unit depends on overall characteristics of the plasma display panel and on applications of the plasma display device.

The R and B image blurring units 113a and 113b may include an average filter, a uniform filter or the like, which is capable of blurring image signals, but not limited thereto.

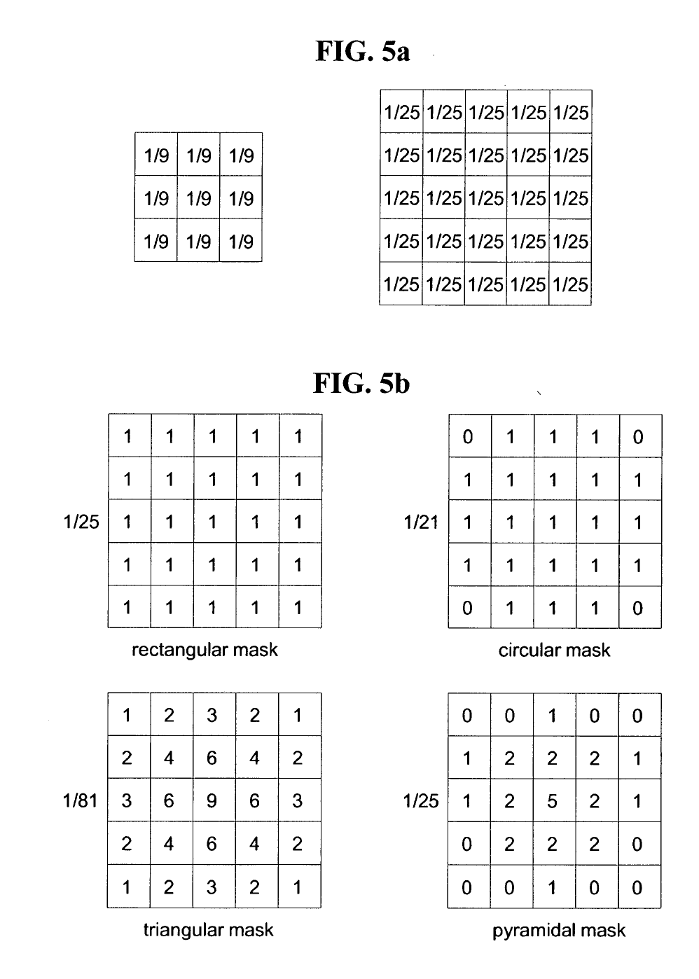

Hereinafter, the principle of the average filter and the uniform filter will be explained in brief. FIG. 5a is a diagram of an average filter. Blurring masks having a size of 3×3 and 5×5 are illustrated in FIG. 5a. The sum of coefficients in pixels of the blurring masks is 1. Accordingly, a coefficient in a pixel of a mask having a size of M×M is 1/(M×M). Since the coefficients in the mask have the same value, each coefficient can be defined as an average of neighboring pixels. Therefore, the image after passing the filter becomes smooth and a difference between gray levels of the image and a neighboring pixel decreases, so that the image becomes blurred.

FIG. 5b is a diagram of a uniform filter. Rectangular, circular, triangular and pyramidal masks are illustrated in FIG. 5b. The sum of coefficients in pixels of the masks is 25, 21, 81 and 25, respectively. The coefficients in the pixels of the mask of the uniform filter are distributed into a rectangular, circular, triangular or pyramidal pattern, so that an image after passing the mask becomes smooth and blurred.

The R and B image blurring units reduce a difference in the gray scale between all lines so as to decrease the brightness, contrast ratio and clarity of the image. Obviously, the number of address switching operations is reduced due to blurring of the R and/or B image signal signals.

Human eyes have sensitivity of 60-70%, 20-30% and approximately 10% respectively to green, red and blue colors. Accordingly, people can not recognize particular decreases in the brightness and clearness of the image even though the R and/or B image signals having relatively low sensitivity are blurred. Because, in the embodiment described above, the output of the G image signal, to which eye sensitivity is the highest, is simply delayed by a predetermined time period that is the same as or close to a blurring process time, people hardly recognize differences in the brightness and clearness of the image.

The bypass unit 114 is operated when the pattern of the image detected from the pattern detecting and determining unit 112 is not identical to the preset specified pattern. In particular, the bypass unit 114 allows the R, G and B image signals, which are inputted to the pattern detecting and determining unit 112, to bypass the blurring unit 113, and the R, G and B image signals are transferred into the sub-field converter 115 without any modification.

The sub-field converter 115 may be electrically coupled to the blurring unit 113 and the bypass unit 114. The sub-field converter 115 may convert R, G and B image signals blurred by the blurring unit 113 or bypassed R, G and B image signals to sub-fields corresponding to a predetermined gray scale, and then output the converted signals. Particularly, the sub-field converter 115 may convert R, G and B image signals blurred by the blurring unit 113 to an address driving signal for gray scale, classify the address driving signals for gray scale by a gray scale, and then rearrange the classified address driving signals for gray scale according to a preset driving sequence. The rearranged address driving signals may be input to the address driver 120.

The image realized by the blurred R and/or B image signals blurred by the blurring unit 113 are fairly decreased in the brightness and clearness thereof (that is, a blurred status), as compared to an original image, so-that the number of R and/or B image address driving signals to be input to the address driver 120 may be fairly reduced. The number of G image address driving signals is maintained as the same as the original image. Accordingly, the original number of G image address driving signals is input to the plasma display panel 150, and simultaneously the reduced number of R and/or B image address signals are input thereto. Therefore, the number of address switching operations is reduced, and thus current and temperature stresses on an address circuit are reduced.

Additionally, a pseudo-outline diminishing unit (not shown) may be electrically coupled to between the blurring unit 113 (or the bypass unit 114) and the sub-field convert 115 in order to diminish a pseudo-outline in various ways. For instance, the pseudo-outline diminishing unit diminishes a pseudo-outline when a specified pattern commonly showing a pseudo-outline (i.e., human face) or a specified moving image is input, so that the pseudo-outline is not displayed on the plasma display panel 150. This method for diminishing the pseudo-outline may include various method of adding 1-2 sub-fields by dividing one sub-field, rearranging a sub-field sequence, preparing sub-fields having a different mode from each other, rearranging the sub-field sequence by adding a sub-field, and using an error diffusion technique, however, the present invention is not limited thereto.

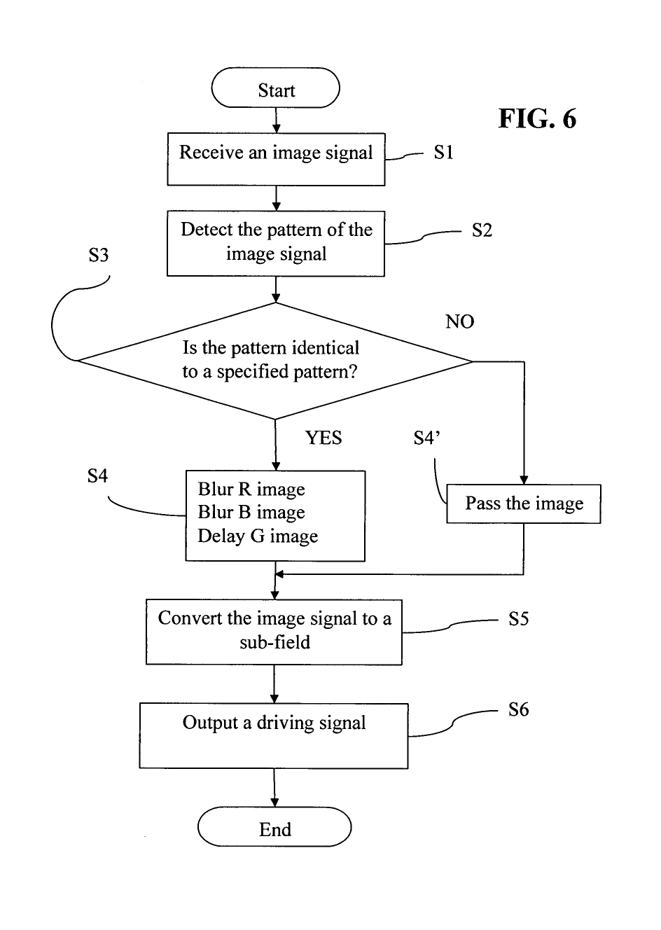

FIG. 6 is a flow chart illustrating an image processing method of the plasma display device 100 of the present invention. The flow chart shown in FIG. 6 shows one process of the embodiments of the present invention, in which R and B image signals are blurred but G image signal is not blurred. Referring to FIG. 6, the image processing method of the plasma display device 100 includes steps of receiving an R, G and B image signals (step S1), detecting a pattern of the received image (step S2), determining whether a preset specified pattern and the pattern of the received image are identical (step S3), and blurring the image signals if necessary (step S4).

Additionally, in the step S3, if the specified pattern and the pattern of the received image are not identical, a bypassing step S4′ is performed instead of the step S4. Further, after the blurring step S4 or the bypassing step S4′, a sub-field converting step S5 and an address driving signal outputting step S6 are sequentially performed.

In the step S1, the R, G and B image signals, which are digitalized and gamma-corrected according to the characteristic of the plasma display panel, may be inputted into a pattern detecting and determining unit. In the step S2, a pattern of the input image, which is represented by the input R, G and B image signals, is detected. For instance, the detected pattern of the input image may be a pattern having the same characteristic as a line on-off pattern or other patterns. In the step S3, it is determined whether the detected pattern of the image is identical to a specified pattern stored in a memory coupled to the pattern detecting and determining unit. The stored specified pattern, for example, can be a line on-off pattern as shown in FIG. 8.

As a result of the determination in the step S3, the blurring process is performed in the step S4 if the detected pattern of the image is the specified pattern, for example, the line on-off pattern. Otherwise, the image signals bypass the blurring step S4, and bypassing step S4′ is performed.

In the blurring step S4, the R image signal and/or blur the B image signal are blurred. Furthermore, the G image signal is simply delayed for a predetermined time period that is the same as or close to a blurring process time, and then outputted. In other words, the R image signal to which human eyes have a sensitivity of approximately 20-30% and/or the B image signal to which human eyes have a sensitivity of approximately less than 10% are blurred. As a result thereof, the number of address switching operations is reduced. The G image signal to which human eyes have a sensitivity of 60-70% is delayed by a blurring time, as a result thereof, the number of address switching operations is not reduced. Accordingly, the entire number of address switching operations is reduced, whereas brightness, contrast ratio and clearness mainly determined by the G image signal are not decreased.

In the sub-field converting step S5, the blurred or bypassed R, G and B image signals are converted to a sub-field suitable for a predetermined gray scale, and the converted sub-fields are output as driving signals. Particularly, in the sub-field converting step (S5), the R, G and B image signals blurred by the blurring unit 113 or the bypassed R, G and B image signals are converted to an address driving signal for gray scale, the address driving signals for gray scale are classified by a gray scale, and the classified address driving signals for gray scale are then rearranged according to a preset driving sequence. The pseudo-outline diminishing step can be performed before the sub-field converting step S5.

Additionally, the address driving signal outputting step S6 is further performed after the sub-field converting step S5. Particularly, the image processing method of the plasma display panel 150 according to the present invention is completed by inputting the address driving signal classified in the sub-field converting step S5 to the address driver 120.

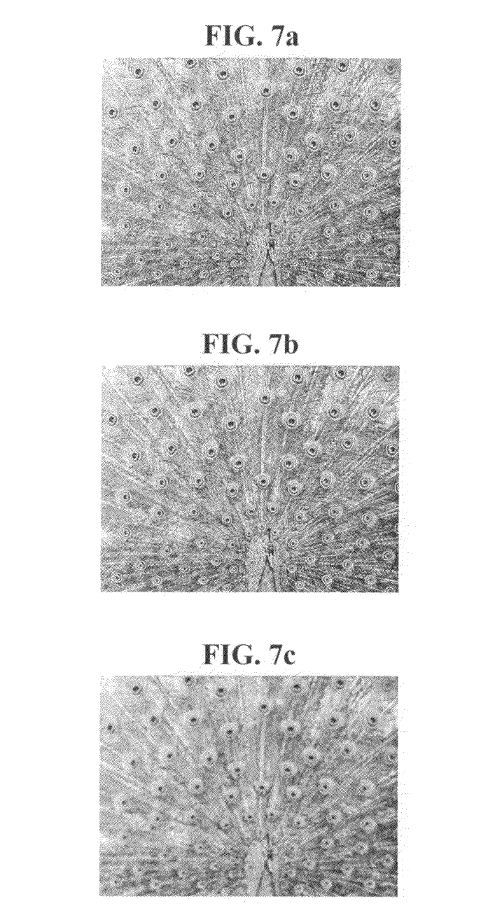

FIGS. 7a through 7c show photos of images that are differently processed through the image burring unit. FIG. 7a shows an original image, which is not modified through the blurring unit, to be input into the plasma display device 100. FIG. 7b shows an image in which both of R and B image signals are blurred through the burring unit. FIG. 7c shows an image in which all of R, B, and G image signals are blurred through the blurring unit.

As shown in FIGS. 7a through 7c, the original image of FIG. 7a and the blurred image of FIG. 7b are similar to each other. It is because green color, which has sensitivity of approximately 60-70%, is the most sensitive to human eyes than red color, which has sensitivity of approximately 20-30%, and blur color, which has sensitivity of approximately 10%. In other words, if only red and blue colors, but not green color, are blurred, human eyes hardly recognize the difference, and people can not recognize decreases in the brightness, contrast ratio and clearness of the image. Even though there is no difference in the image quality, the number of address switching operations is relatively reduced in the plasma display device 100, so that current and temperature stresses on an address switch are relatively alleviated.

Referring to FIG. 7c, the image of FIG. 7c is slightly different from the images of FIGS. 7a and 7b. In the image of FIG. 7c, all of the red, blue, and green colors are blurred, and therefore human eyes easily recognize the difference, because human eyes are more sensitive to the green color than the red and blue colors.

Because human eyes are sensitive to brightness components rather than colors and the type and resolution of a real image are mainly determined by a green color, the green color is delayed and outputted without being blurred, while red and/or blue colors are blurred and outputted. Therefore, the number of address switching operations corresponding to the blurred red and/or blue colors is reduced. Accordingly, current and temperature stresses on an address switch are decreased, whereas since the brightness, contrast ratio and clearness of an image to be displayed are little decreased by being determined by the green color.

Additionally, although information for red and blue colors is varied from an original image, a human being can recognize the original image as the same brightness and color as those of the original image due to integration property of human eyes. For instance, when a cell having values of 1 and 0 is adjacent, the brightness of red and blue colors is recognized as an average brightness of 0.5 from a sufficient distance. Therefore, according to the present invention, the red and blue colors lost information for clarity from the original image. However, the green color faithfully maintains the resolution and clarity of the original image. As a result thereof, there is no variation in the local average brightness of the red and blue colors and thus image quality thereof has little difference from the original image.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A plasma display device comprising:
a pattern detecting and determining unit detecting a pattern of an image that is represented by a red (R), a blue (B), and a green (G) image signals, the pattern detecting and determining unit determining whether the detected pattern of the image is identical to a preset specified pattern; and
a blurring unit coupled to the pattern detecting and determining unit, the blurring unit blurring at least one of R, G, and B image signals if the detected pattern of the image is identical to the preset specified pattern.

2. The plasma display device of claim 1, wherein the preset specified pattern includes a line on-off pattern.

3. The plasma display device of claim 1, wherein the blurring unit blurs the R image signal.

4. The plasma display device of claim 1, wherein the blurring unit blurs the B image signal.

5. The plasma display device of claim 1, wherein the blurring unit delays the output of the G image signal by a time period that is required to blur at least one of R and B image signals.

6. The plasma display device of claim 1, wherein the blurring unit blurs at least one of the R and B image signals and delays the G image signal by the blurring process time of the at least one of the R and B image signals.

7. The plasma display device of claim 1, further comprising:
a sub-field converter electrically coupled, to the blurring unit, the sub-field converter converting R, B, and G image signals output from the blurring unit to a sub-field corresponding to a predetermined gray scale, if the detected pattern of the image is identical to the preset specified pattern.

8. The plasma display device of claim 1, further comprising:
a bypass unit electrically coupled to the pattern detecting and determining unit, the R, G, and B image signals passing through the bypass unit and not passing through the blurring unit if the detected pattern of the image is not identical to the preset specified pattern.

9. The plasma display device of claim 8, further comprising:
a sub-field converter electrically coupled to each of the blurring unit and the bypass unit, the sub-field converter converting R, B, and G image signals output from the blurring unit or from the bypass unit to a sub-field corresponding to a predetermined gray scale.

10. An image processing method of the plasma display device comprising:
detecting a pattern of an image that is represented by a red (R), a green (G), and a blue (B) image signals;
determining whether the detected pattern of the image is identical to a preset specified pattern; and
blurring at least one of the R, G and B image signals if the detected pattern of the image is identical to the preset specified pattern.

11. The image processing method of claim 10, wherein the preset specified pattern includes a line on-off pattern.

12. The image processing method of claim 10, wherein the step of blurring at least one of the R, G, and B image signals includes a step of blurring the R image signal.

13. The image processing method of claim 10, wherein the step of blurring at least one of the R, G, and B image signals includes a step of blurring the B image signal.

14. The image processing method of claim 10, wherein the step of blurring at least one of the R, G, and B image signals includes a step of delaying the output of the G image signal by a time period that is required to blur at least one of R and B image signals.

15. The image processing method of claim 10, wherein the step of blurring at least one of the R, G and B image signals further comprising:
blurring at least one of R and B image signals; and
delaying the output of the G image signal by a time period that is required to blur the at least one of R and B image signals.

16. The image processing method of claim 10, further comprising:
converting the blurred at least one of the R, B, and G image signals to a sub-field corresponding to a predetermined gray scale, if the detected pattern of the image is identical to the preset specified pattern.

17. The image processing method of claim 10, further comprising:
not blurring the R, G and B image signals, if the detected pattern of the image is not identical to the preset specified pattern.

18. The image processing method of claim 17, further comprising:
converting the not blurred R, B, and G image signals to a sub-field corresponding to a predetermined gray scale, if the detected pattern of the image is not identical to the preset specified pattern.
